(19) United States
(12) Patent Application Publication
(10) Pub. No.: US 2012/0017237 A1
(43) Pub. Date: Jan. 19, 2012

(54) Delivering Advertisements Based on Digital Television System and Mobile Communication Device

(76) Inventor: Yang Pan, Singapore (SG)

(21) Appl. No.: 12/838,436

(22) Filed: Jul. 17, 2010

(51) Int. Cl. H04N 7/025

(52) U.S. Cl. 725/32

(57) ABSTRACT

A system for delivering advertisements based on a digital television system and a mobile communication device is disclosed. The television system and the mobile device are connected in ad hoc manner when a program is broadcasted by the television system. When a user is attracted by an advertisement, an instruction is sent from a remote control device of the television system or from the mobile device to trigger the processor of the television system to send a data file including a product identifier related to the product being advertised to the mobile device. An icon is displayed on a display screen of the mobile device to represent the received data file. When the icon is selected, the mobile device is connected to a data manager in the Internet to deliver more product information to the user.

### CROSS-REFERENCE TO RELATED APPLICATIONS

Not applicable.

### BACKGROUND

1. Field of Invention

This invention relates generally to advertising. More specifically, the invention relates to system and method for delivering advertisements to a mobile communication device.

2. Description of Prior Art

Advertising using television is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone from Apple Inc, Cupertino, Calif., to access the Internet services. Methods for delivering targeted advertisements to users by employing mobile communication devices have been developed. The targeted advertising messages may be delivered based upon the user's personal profile, location and history of the user's interaction with the device.

Even when sometimes the advertisements broadcasted by the television are attracted by a viewer, the information provided by the television is often insufficient for the viewer to make a purchasing related decision.

The adoption of digital television system has opened up new opportunities to deliver advertisements to targeted customers. The opportunities, however, have not been fully explored, in particularly, when the digital television system and the mobile communication are combined.

### SUMMARY OF THE INVENTION

It is an object of the present invention to disclose a system and method for delivering highly targeted advertisements to a user of a digital television system and a mobile communication device.

In accordance with one embodiment of the present invention, the digital television (TV) system is used to deliver media assets to a viewer. Advertisements may be delivered to the viewer based on a predetermined schedule. The digital TV system may be connected to a mobile communication device through an ad hoc communication link such as through a Bluetooth connection. If the viewer is interested in the advertisement being displayed, he or she may use the remote control to send a control signal to the TV system. A data file stored in a buffer of the TV system may be sent to the mobile device through the ad hoc communication link. The received file may be represented by an icon on a display screen of the mobile device according to one implementation. The data file may include a product identifier related to the advertisement.

The user may select the icon for more detailed information about the product. When selected, the mobile device is connected to a data manager through the Internet. The information delivered to the viewer from the data manager may include but not limited to pricing, features, reliability, commercial terms and customer rating. The information may also include pricing comparison from different retailers. The viewer may decide to purchase the product through an on-line facility.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an advertisement delivery system based on a digital TV system and a mobile communication device in accordance to one embodiment;

FIG. 2A is a schematic diagram of functional blocks and data flow of the system in accordance with one embodiment;

FIG. 2B is a schematic diagram of functional blocks and data flow of the system in accordance with another embodiment;

FIG. 3A is a schematic diagram of functional blocks of the digital TV system in accordance with one implementation;

FIG. 3B is a schematic diagram of functional blocks of the mobile communication device in accordance with one implementation;

FIG. 4 is a flowchart illustrating an exemplary process that a data file related to the advertisement be displayed is delivered from the digital TV system to the mobile device.

FIG. 5 is a flowchart illustrating an exemplary process that an icon is used to represent the received data file and more detailed information about the product is delivered from a data manager connected to the Internet.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

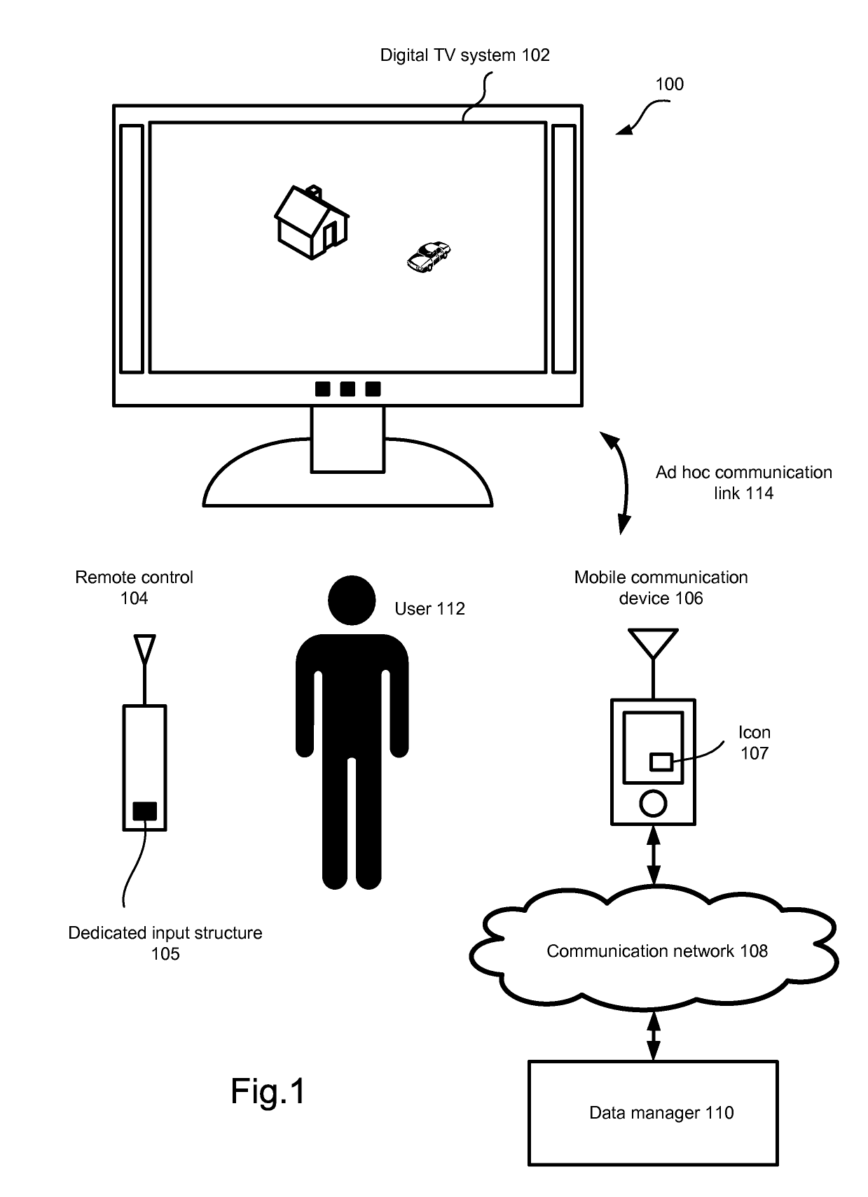

FIG. 1 is a schematic diagram illustrating an advertisement delivery system according to one embodiment. The system 100 comprises a digital TV system 102 with a remote control device 104. The remote control device 104 may include a dedicated input structure 105 for controlling of transmitting of advertisement from the TV system 102 to the mobile communication device 106 according to one embodiment of the present invention. The input structure 105 may be a button, a touch pad or an icon in a touch sensitive display. The mobile communication device 106 may be a mobile phone with the internet connection capability. The mobile device 106 is connectable to a data manger 110 through the Internet 108. The mobile communication device 106 may include an icon representing an advertisement received from the digital TV 102. A user 112 operates the system. The remote control device 104 and the digital TV system 102 are connected through a well known method such as the Infrared communication interface in the art. The digital TV system 102 and the mobile device 106 may be connected using an ad hoc communication link 114. The ad hoc communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC).

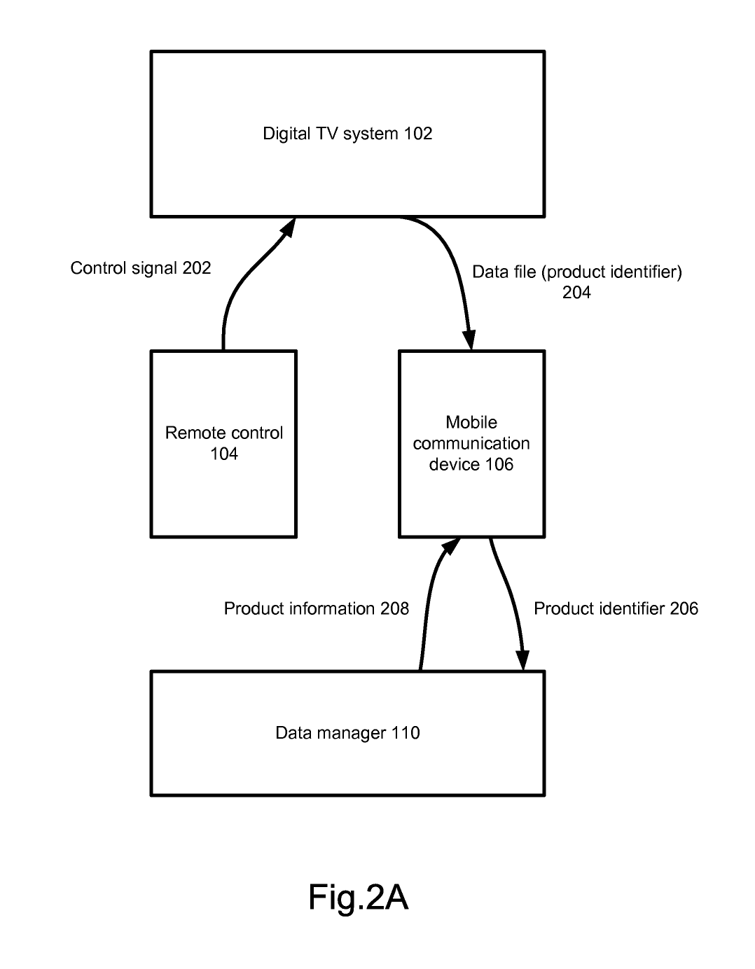

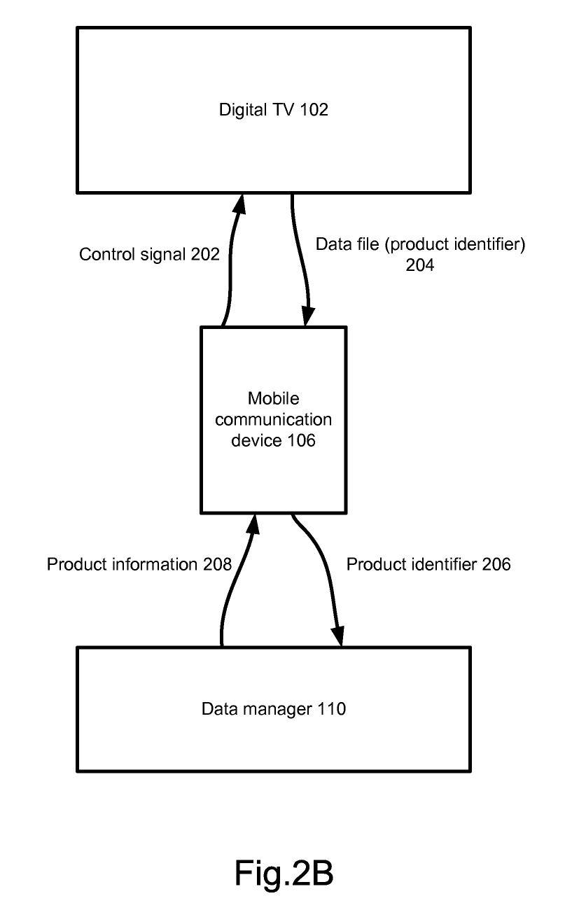

FIG. 2A is a schematic diagram of functional blocks and data flow of the system 100 in accordance with one embodiment. When a digital TV system 102 is used to broadcast a program, advertisements may be inserted and be broadcasted based on a predetermined schedule. When a specific advertisement is being broadcasted, the related data such as its product identifier may be stored temporally in a buffer of the TV system 102 as a data file 204. If the viewer is attracted by the advertisement and wants to know more about the product, he or she may use the remote control 104 to send a control signal 202 to the digital TV system 102. After receiving the control signal 202, the digital TV system 102 will send the stored data file 204 to the mobile device 106. The data file 204 may be represented by an icon displayed on a display screen of the mobile device 106. If the icon is selected by the user 112, the product identifier 206 is sent to a data manager 110 through the Internet 108. The data manager 110 sends more detailed product information to the mobile device 106. The product information 208 may be presented using a web site displayed on the display screen of the mobile device 106. It should be noted that data file 204 sent from digital TV system 102 to the mobile device 106 may include content other than the product identifier. For example, the data file may include a text message, an image, a voice message, video clip and a multimedia file related to the advertisement being played. The user may use the mobile device 106 to view the received data file.

The remote control device 104 may include a dedicated input structure 105 for delivering the control signal 202. The dedicated input structure 105 may be a button, a touch pad, an icon in a touch sensitive screen or any other structure as known in the art. When the input structure is actuated, a processor in the remote control 104 receives the signal and sends the control signal to the digital TV system 102.

According to another implementation, one of the existing input structures of the remote control device 104 may be used to display a control menu on the screen of the digital TV system 102. The control menu may include at least one user selectable item. After the selection using the remote control device 104, a control signal is generated to trigger the operation of sending the data file 204 to the mobile device 106.

FIG. 2B is a schematic diagram of functional blocks and data flow of the system 100 in accordance with another embodiment. The mobile communication device 106 rather than the remote control device 104 is used to send a control signal 202 to the digital TV system 102. If the viewer is attracted by the advertisement and wants to know more about the product, he or she may use the mobile device 106 to send a control signal 202 to the digital TV system 102. According to one implementation, an input structure may be actuated to display a control menu on the screen of the mobile device 106. The control menu may include at least one user selectable item. After the user selects the item, a control signal 202 is generated and is sent to the digital TV system 102. The data file 204 is then sent to the mobile device 106. Similarly, the product identifier 206 may be sent the data manger 112 and product information 208 is sent to the mobile device in a form of web site.

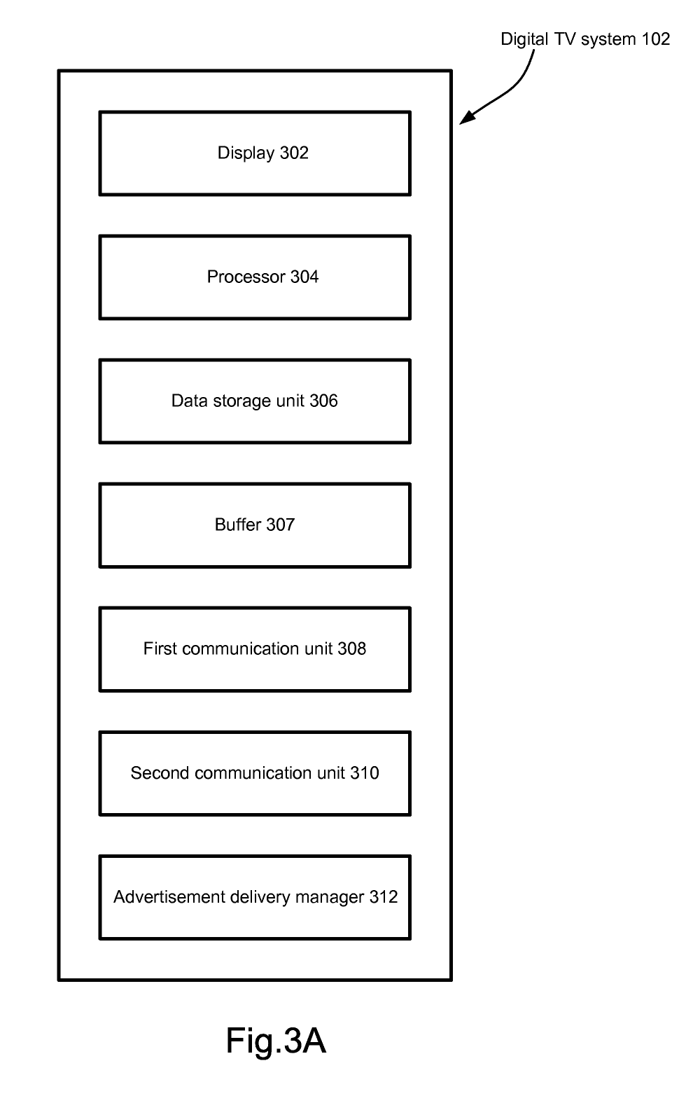

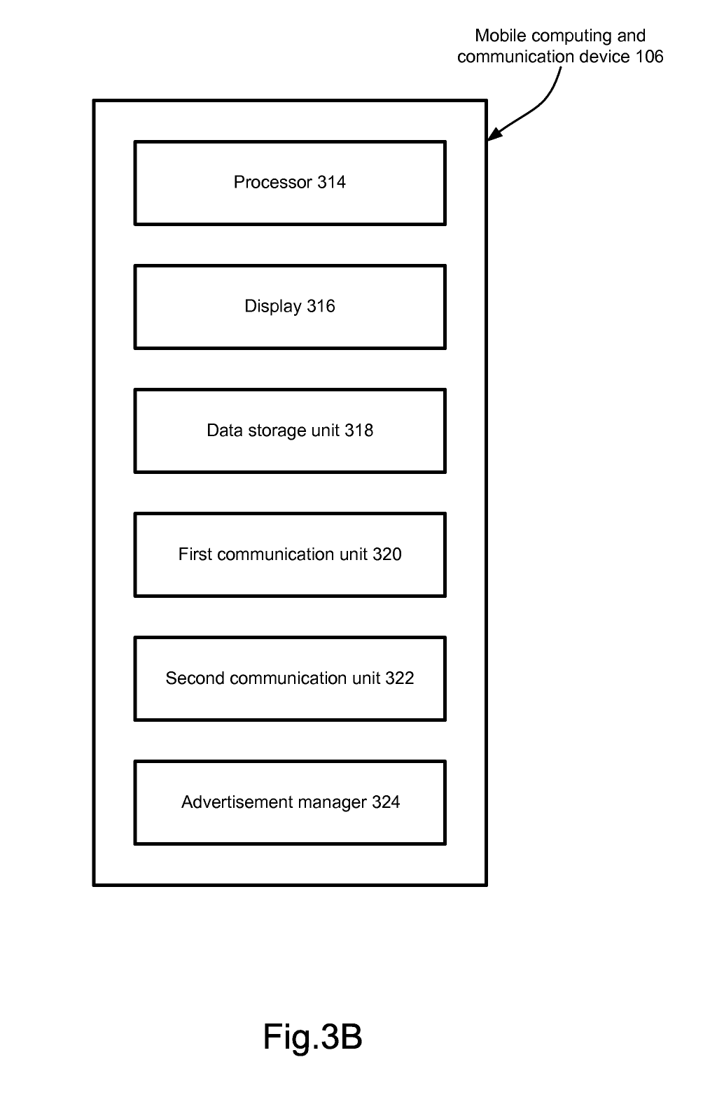

FIG. 3A is a schematic representation of functional blocks of the digital TV system 102 in according with one embodiment. The system 102 comprises a display 302. The display may be a Liquid Crystal Display (LCD). The display may also be any other type of display as known in the art. A processor 304 is used to control the operation of the digital TV system 102. The processor 304 may include more than one type of processors including a general purpose processor such as a Central Processing Unit (CPU) and a special purpose processor such as a Graphical Processing Unit (GPU). The system 102 may also include a data storage unit such as a magnetic storage unit and/or semiconductor memory devices. A buffer 307 is used to provide shorter access time. A buffer may be implemented using Static Random Access Memory (SRAM). When an advertisement is being broadcasted, a data file related to the advertisement may be stored in the buffer temporally.

The digital TV system 102 may be connected to a communication network through a first communication unit 308. The network may be a private broadband network for delivering TV programs. The network may also be a public network such as, for example, the Internet. A second communication unit 310 is used to connect the digital system 102 to the mobile device 106 through an ad hoc communication link 114. The ad hoc communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). The digital TV system 102 may also include a third communication unit (not shown in the figure) for connecting the system and the remote control device 104. Most remote control devices today use Infrared communication interfaces.

An advertisement delivery manager 312 is used to control the operation of the advertisement delivery. It may be implemented as a software program to be executed by the processor 304. It may also be implemented as a combination of the software and the hardware.

FIG. 3B is a schematic representation of functional blocks of the mobile communication device 106. The device 106 comprises a processor 314, a display 316, a data storage unit 318 and a first communication unit 320 as known in the art. The first communication unit 320 may be a standard network interface for a smart phone including a capability to connect to the Internet. The device 106 further comprises a second communication unit 322 for connecting to the digital TV system 102 through the previously mentioned ad hoc communication link 114. An advertisement manager 324 is used to control the operation of receiving the data file 204 and to display an icon to represent the received data file in an exemplary implementation.

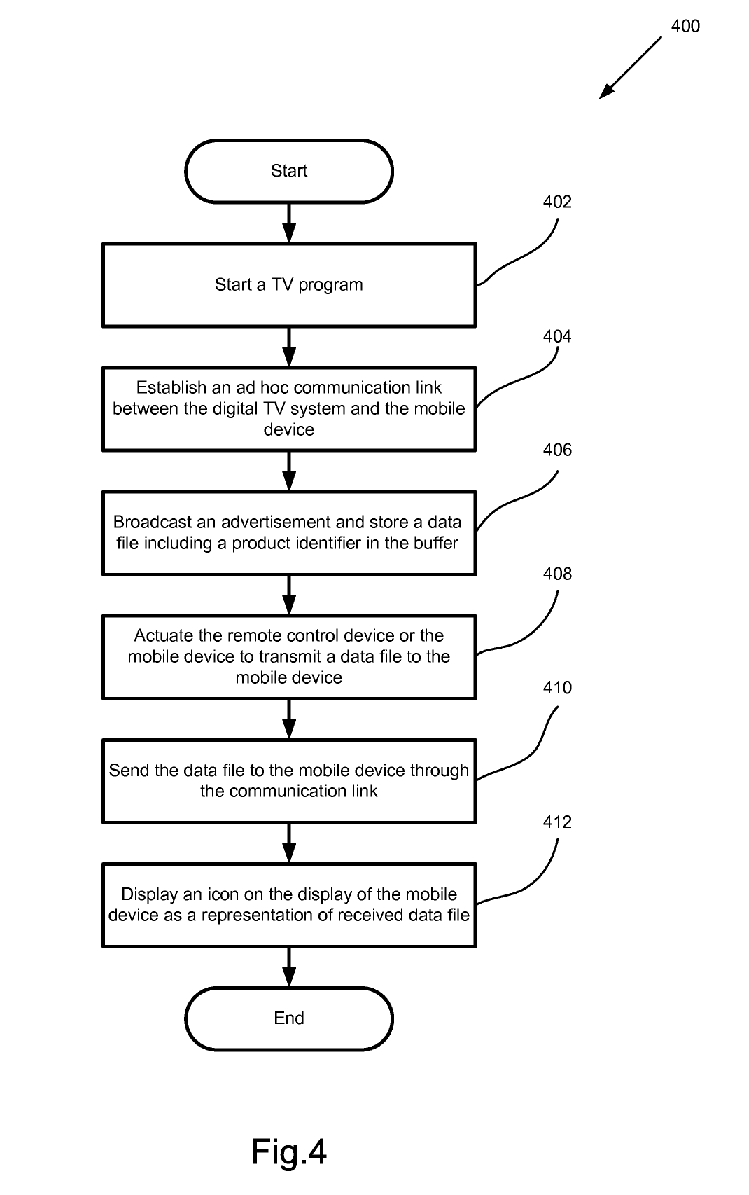

FIG. 4 is a flowchart illustrating a process that the data files related to an advertisement is transmitted from the digital TV system 102 to the mobile device 106. Process 400 begins with starting a TV program in step 402. An ad hoc communication link 114 is established in step 404 between the digital TV system 102 and the mobile device 106. The communication link 114 may be a Bluetooth connection in an exemplary implementation. The communication link may also be a NFC including a RF tag in the digital TV system 102 and a reader in the mobile device 106 in another exemplary implementation. The data file may be sent to the tag first before it is transmitted to the mobile device 106.

An advertisement is broadcasted in step 406 according to a predetermined schedule. The data file including a product identifier is stored in the buffer 307 of the digital TV system 102. In step 408, the remote control device 104 is actuated by the viewer 112. The viewer 112 may actuate a dedicated input structure 105 according to one implementation. The viewer 112 may also actuate a non-dedicated input structure to have a control menu displayed in a selected area of the display screen of the digital system 102 according to another implementation. The user 112 may select a user selectable item. As a result, a control signal is sent to the processor 304 to start an operation of transmitting the data file. In step 410, the data file 204 including the product identifier is sent to the mobile device 106 through the ad hoc communication link 114. An icon 107 representing the received data file is displayed on the display screen of the mobile device 106 in step 412.

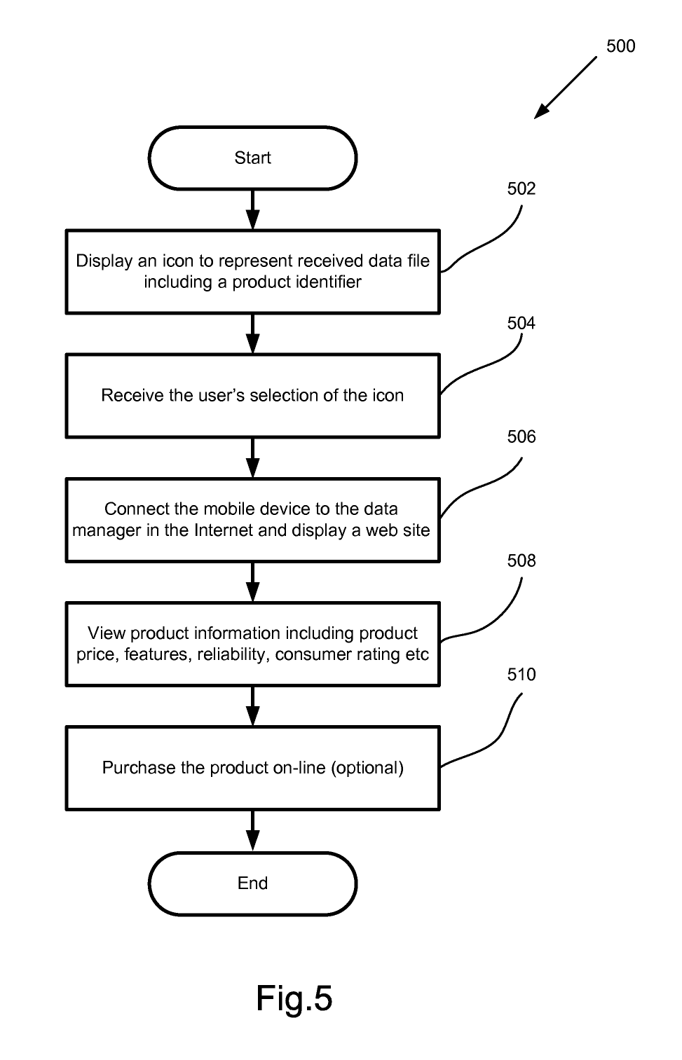

FIG. 5 is a flowchart illustrating a process that detailed product information is sent to the mobile device 106 from the data manager 110 through the Internet 108. Process 500 starts with step 502 that the icon 107 representing the received data file 204 is displayed on the screen of the mobile device 106. The display may be a touch sensitive screen according to one implementation. The user (viewer) may touch the icon 107 in step 504 to request the detailed product information. The mobile device 106 and the data manager 110 are connected through the Internet 108 in step 506. The data manager 110 may be an operator to provide detailed product information when receiving a request. The data manager 110 may be connected to retailers, advertisers and consumer rating organizations. After they are connected, a web page may be displayed. The product information represented by the product identifier may be delivered to the user 112 in a hierarchical manner as known in the art. The user may navigate through the user interface and find useful information related to the product. In step 510, the user may decide to purchase the product through an on-line facility after reviewing the product information.

The user's operation may be tracked and data may be collected and be sent back to the digital TV system 102. The advertisers may be paid based on which product identifiers are downloaded by the viewer and also by which product the user purchased through the on-line facility.

1. An advertisement delivery system comprising:
a digital television system including a remote control device;
a mobile communication device; and
a communication means for transmitting a data file, related to an advertisement being broadcasted, from the television system to the mobile device.

2. The system as recited in claim 1, wherein said data file further including a product identifier related to at least one product being advertised by the television system.

3. The system as recited in claim 1, wherein said digital television system further comprising:
a display screen;
a processor;
a data storage unit;
a buffer;
a first communication unit for connecting to a communication network;
a second communication unit for connecting to the mobile device; and
an advertisement delivery manager for storing the data file in the buffer and for transmitting the file to the mobile device.

4. The system as recited in claim 1, wherein said mobile communication device further comprising:
a processor;
a display;
a data storage unit;
a first communication unit for connecting to a public communication network;
a second communication unit for connecting to the digital television system; and
an advertisement manager for displaying an icon after receiving the data file.

5. The system as recited in claim 4, wherein said icon, when selected by the user's action, will connect the mobile device to a data manager in a public communication network including the Internet, wherein the data manager may provide product information including pricing, features, commercial terms, reliability and customer rating.

6. The system as recited in claim 5, wherein said data manager further providing a means of connecting to one or a plurality of retailers, to one or a plurality of manufacturers, and to one or a plurality of customer rating organizations.

7. The system as recited in claim 1, wherein said communication means conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

8. The system as recited in claim 1, wherein said data file further comprising an advertising message including one or a combination of the following data:
a text message;
an image;
a voice message;
a video clip; and
a multimedia file.

9. The system as recited in claim 1, wherein said remote control device further comprising a dedicated input structure for receiving the user's instruction to transmit the data file.

10. The system as recited in claim 1, wherein said digital television system further comprising a user interface program including a user selectable item for transmitting the associated data file when an advertisement is being broadcasted by the television system.

11. The system as recited in claim 1, wherein said mobile device further comprising a user interface program including a user selectable item for transmitting the associated data file when an advertisement is being broadcasted by the television system.

12. A method of delivering an advertising message to a mobile communication devices comprising:
establishing an ad hoc communication link between a digital television system and the mobile device;
broadcasting an advertisement by the television system and storing a data file including a product identifier related to the product being advertised in a buffer of the television system;
actuating an input structure of a remote control device of the television system; and
sending the data file to the mobile device through the communication link.

13. The method as recited in claim 12, wherein said method further comprising:
displaying an icon on a display of the mobile device;
selecting the displayed icon by the user;
connecting the mobile device to a data manager in the Internet; and
presenting product information represented by the product identifier.

14. The method as recited in claim 13, wherein said method further comprising purchasing the advertised product through an on-line facility.

15. The method as recited in claim 12, wherein said operation of “actuating” the remote control device further comprising sending a control signal to the television system to display a control menu including a user selectable item to transmit the data file to the mobile device.

16. The method as recited in claim 12, wherein said communication link conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

17. A method of delivering an advertising message to a mobile communication devices comprising:
establishing an ad hoc communication link between a digital television system and the mobile device;
broadcasting an advertisement by the television system and storing a data file including a product identifier related to the product being advertised in a buffer of the television system;
starting a control menu including a user selectable item in the mobile device to receive the data file;
sending a control signal to the television system through the ad hoc communication link; and
sending the data file to the mobile device.

18. The method as recited in claim 17, wherein said method further comprising:
displaying an icon on a display of the mobile device;
selecting the displayed icon by the user;
connecting the mobile device to a data manager in the Internet; and
presenting product information represented by the product identifier.

19. The method as recited in claim 18, wherein said method further comprising purchasing the advertised product through an on-line facility.

20. The method as recited in claim 17, wherein said ad hoc communication link conforming to one of or a combination of the following standards:
Bluetooth (IEEE 802.15.1 and its extensions);
ZigBee (IEEE 802.15.4 and its extensions);
WiFi (IEEE 802.11x and its extensions);
NFC (ISO 18092; or ISO 21481).
